(19) United States
(12) Patent Application Publication
(10) Pub. No.: US 2023/0074069 A1
(43) Pub. Date: Mar. 9, 2023

(54) Multipurpose Kitchen Cooking Appliance and Method of Use Thereof

(71) Applicant: Damion Willis, Panama City, FL (US)

(72) Inventor: Damion Willis, Panama City, FL (US)

(21) Appl. No.: 17/940,605

(22) Filed: Sep. 8, 2022

Related U.S. Application Data
(60) Provisional application No. 63/241,655, filed on Sep. 8, 2021.

(51) Int. Cl. A47J 36/32; A23L 5/10

(52) U.S. Cl. CPC A47J 36/321; A23L 5/10; A23V 2002/00

(57) ABSTRACT

The present invention relates to a multipurpose kitchen appliance designed to prepare a meal in an autonomous manner. The kitchen appliance is equipped with at least a refrigerator, a stove, a deep fryer, an oven, a coffee maker, and/or a plurality of storage trays. The storage trays are configured to store seasonings, food items, and more and are programmed to transfer a predetermined amount to a cooking appliance based on the type of recipe selected by a user. An internal memory stores a plurality of recipes for selection by a user wherein the recipes can be imported by a user and are executed by a recipe execution engine. The kitchen appliance can be controlled and operated using a remote electronic device and can be used for preparing different recipes easily and autonomously.

### CROSS-REFERENCE TO RELATED APPLICATION

The present application claims priority to, and the benefit of, U.S. Provisional Application No. 63/241,655, which was filed on Sep. 8, 2021 and is incorporated herein by reference in its entirety.

### FIELD OF THE INVENTION

The present invention relates generally to the field of cooking apparatuses. More specifically, the present invention relates to a novel kitchen appliance that is designed to prepare pre-stored recipes in an automated manner without requiring manual intervention. The appliance has storage space for ingredients and food items, a plurality of cooking appliances, and a recipe execution engine. The appliance can be operated remotely by a user using a remote electronic device. Accordingly, the present disclosure makes specific reference thereto. Nonetheless, it is to be appreciated that aspects of the present invention are also equally applicable to other such as applications, devices, and methods of manufacture.

### BACKGROUND

By way of background, with the busy schedule of individuals and lack of time, cooking healthy meals on a daily basis can be incredibly difficult. Due to time and effort consumed in preparing meals, individuals may opt for less healthy meals such as fast food and more. These not only pose a threat to the health of individuals but are also expensive. Generally, individuals manually use cooking apparatuses for preparing meals which may not always be possible for individuals who do not know cooking. As a result, individuals end up consuming meals prepared by others and other unhealthy/fast food. Individuals desire a device that can autonomously prepare food items and meals without any user intervention.

In the recent past, cooking devices have started to become intelligent but even in such devices, manual intervention is required and multiple steps are necessary to prepare a meal. Proper operation of such devices requires manual supervision and physical presence of a user. Individuals desire an improved kitchen device that can overcome shortcomings in such conventional cooking devices.

Cooking meals require a lot of utensils and appliances which may not always be available to users. As a result, individuals may end up not preparing their favorite dishes. Therefore, individuals desire a kitchen appliance that can include a plurality of cooking appliances.

Therefore, there exists a long felt need in the art for a kitchen appliance that is equipped with a plurality of cooking and food storage appliances. There is also a long felt need in the art for a kitchen appliance that autonomously prepares food items and meals without manual intervention. Additionally, there is a long felt need in the art for a kitchen appliance that enables users to create meals and recipes with ease. Moreover, there is a long felt need in the art for a device that enables users to store their favorite recipes for autonomous preparation. Further, there is a long felt need in the art for a kitchen appliance that does not require physical presence of a user for operation and configuration. Furthermore, there is a long felt need in the art for a device that meets the special needs of individuals for autonomous preparation of food items and meals preparation. Finally, there is a long felt need in the art for a device that eliminates the need of users to manually cook meals.

The subject matter disclosed and claimed herein, in one embodiment thereof, comprises a unique kitchen appliance configured to include at least a refrigerator, a stove, a deep fryer, and an oven for autonomous preparation of meals. The appliance is designed to autonomously prepare pre-stored recipes on request of a user or at a scheduled time. The appliance features a plurality of storage trays for storing different pre-seasoned meats, seafood, vegetables, cereals, pancake mixtures, eggs, bacon, stock water, and/or numerous other ingredients for preparing recipes. The appliance is configured to provide semi-automated or automated cooking processes wherein a processor and a recipe program execution engine of the appliance executes the recipe instructions to prepare the recipe in an automated manner. More specifically, the recipe instructions of pre-stored recipes in internal memory are decoded and ingredients from the storage trays are transferred to a cooking appliance for preparing a meal. A user can manually select a recipe either through a touch interface of the appliance or using a remote electronic device via a wireless communication channel.

In this manner, the kitchen appliance of the present invention accomplishes all of the forgoing objectives and provides users with an improved multipurpose kitchen appliance equipped with a refrigerator, a stove, storage compartments, a coffee maker, and other technological features. The appliance enables users to pre-program the system to autonomously make a meal via Wi-Fi and Bluetooth, creating a menu that the system can follow through measurements, seasonings, etc. and setting it to activate at a certain time. The appliance eliminates the need to manually cook meals, improves overall health, and assists individuals with hectic work schedules in order to prepare and consume homecooked meals.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a unique kitchen appliance configured to function as at least a refrigerator, a stove, a deep fryer, and an oven. The appliance is designed to autonomously prepare pre-stored recipes upon user requested or scheduled times. The appliance features a plurality of storage trays for storing different pre-seasoned meats, seafood, vegetables, cereals, pancake mixtures, eggs, bacon, stock water, and/or numerous other ingredients for preparing recipes. The appliance is configured to provide semi-automated or automated cooking process wherein a processor and a recipe program execution engine of the appliance execute the steps of the recipe to prepare the recipe in an automated manner. More specifically, the recipe instructions of pre-stored recipes in internal memory are decoded and ingredients from the storage trays are transferred to a cooking appliance for preparing a meal.

In yet another embodiment, a multifunctional kitchen cooking appliance is disclosed. The kitchen appliance is designed to prepare a recipe selected by a user or selected as per stored preferences of the user without user intervention. The kitchen appliance includes a plurality of cooking appliances including at least an oven, a deep fryer, and a stove; a refrigerator; a plurality of storage trays for storing ingredients for making a recipe; an input and output module for receiving a user input and displaying notifications to the user; and, an integrated memory module for storing a plurality of recipe instructions, a recipe instructions execution engine for executing recipe instructions and a processor for providing instructions to said cooking appliances and storage trays wherein ingredients required for preparing the recipe are autonomously transferred to one or more cooking appliances. A dispenser is provided for dispensing the prepared recipe thereby obviating the need of users to manually cook meals.

In one embodiment, the appliance has a clock for setting a predefined (i.e., scheduled) time at which a recipe is selected from the memory module and is executed by the recipe instructions execution engine and the processor.

In yet another embodiment, the kitchen appliance is wirelessly connected to a remote electronic device, the electronic device is configured to provide a plurality of controls to operate and configure the kitchen appliance wherein the controls include a recipe selection control for controlling a recipe from a plurality of pre-stored recipes, a timer selection control for selecting a scheduled time for automatic selection of at least one recipe, a meal selection control for selecting a meal at the scheduled time, an import recipes control for autonomously importing or downloading one or more recipes in memory module of the appliance, a storage trays program module for programming identification numbers to the trays and a quantity of dispensing an ingredient from the each tray.

In yet another embodiment, a control module of the appliance has a recipe program execution engine configured to access recipe instructions pre-stored in the memory module. The recipe instructions are configured to be executed by the cooking appliances under the control of the processor and the execution engine.

It is an object of the present invention to provide a new and improved kitchen cooking appliance that has all of the advantages of a plurality of cooking appliances that can be easily used at homes, restaurants, and in other businesses. The kitchen appliance is easily and efficiently manufactured and marketed and has a low cost of manufacture with regard to both materials and labor, and which accordingly is then amenable of low prices of sale to the consuming public, thereby making such kitchen appliances economically available to the buying public.

Numerous objects, features and advantages of the kitchen appliance will be readily apparent to those of ordinary skill in the art upon reading the following detailed description of presently preferred, but nonetheless illustrative, embodiments of the kitchen appliance when taken in conjunction with the accompanying drawings. In this respect, before explaining the current embodiments of the kitchen appliance in detail, it is to be understood that the invention is not limited in its application to the details of construction and arrangements of the components set forth in the following description or illustration. The invention is capable of other embodiments and of being practiced and carried out in various ways. It is also to be understood that the phraseology and terminology employed herein are for purposes of description and should not be regarded as limiting.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a simplified component diagram of one potential embodiment of a multipurpose kitchen appliance of the present invention in accordance with the disclosed architecture;

FIG. 2 illustrates a perspective view of the multifunctional kitchen appliance of the present invention in accordance with the disclosed architecture;

FIG. 3 illustrates a schematic view showing the connection of the kitchen appliance with a remote electronic device for remotely operating the kitchen appliance in accordance with the disclosed architecture;

FIG. 4 illustrates a flow diagram depicting steps performed for autonomous preparation of a meal by the kitchen appliance of the present invention in accordance with the disclosed architecture;

FIG. 5 illustrates a flow diagram depicting determination of required ingredients for a recipe by the kitchen appliance of the present invention in accordance with the disclosed architecture; and

FIG. 6 illustrates a flow chart depicting a process of programming storage trays of the kitchen appliance of the present invention in accordance with the disclosed architecture.

### DETAILED DESCRIPTION OF THE PRESENT INVENTION

The innovation is now described with reference to the drawings, wherein such as reference numerals are used to refer to such as elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a kitchen appliance that is equipped with a plurality of cooking and food storage appliances. There is also a long felt need in the art for a kitchen appliance that autonomously prepares food items and meals without manual intervention. Additionally, there is a long felt need in the art for a kitchen appliance that enables users to create meals and recipes with ease. Moreover, there is a long felt need in the art for a device that enables users to store their favorite recipes for autonomous preparation. Further, there is a long felt need in the art for a kitchen appliance that does not require physical presence of a user for operation and configuration. Furthermore, there is a long felt need in the art for a device that meets the special needs of individuals for autonomous preparation of food items and meals preparation. Finally, there is a long felt need in the art for a device that eliminates the need of users to manually cook meals.

The present invention, in one exemplary embodiment, is a multifunctional kitchen cooking appliance. The kitchen appliance is designed to prepare a recipe selected by a user or selected as per stored preferences of the user without user intervention. The kitchen appliance includes a plurality of cooking appliances including at least an oven, a deep fryer, and a stove; a refrigerator; a plurality of storage trays for storing ingredients for making a recipe; an input and output module for receiving a user input and displaying notifications to the user; and, an integrated memory module for storing a plurality of recipe instructions, a recipe instructions execution engine for executing recipe instructions and a processor for providing instructions to said cooking appliances and storage trays wherein ingredients required for preparing the recipe are autonomously transferred to one or more cooking appliances.

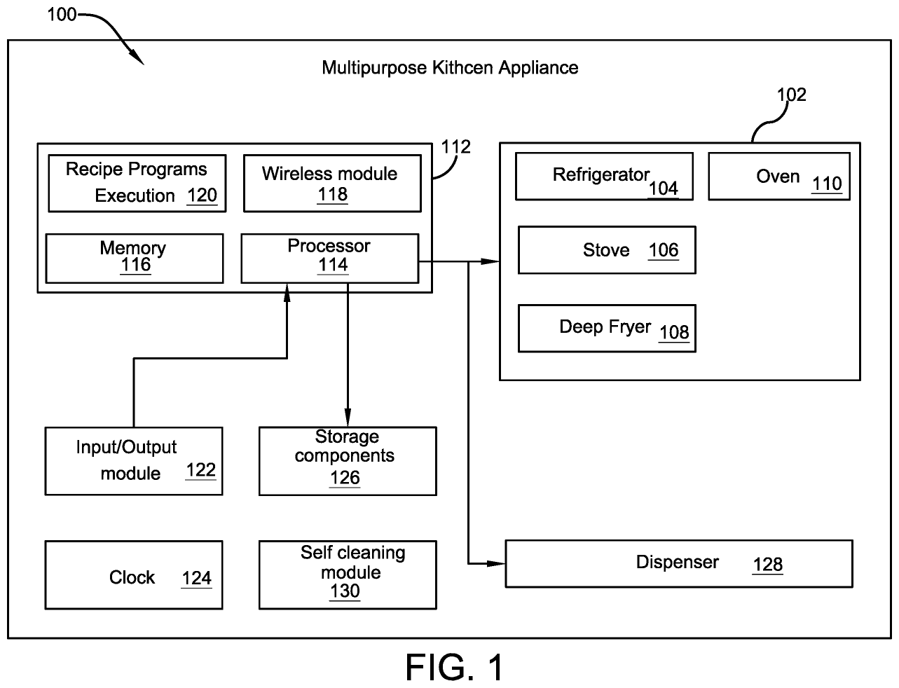

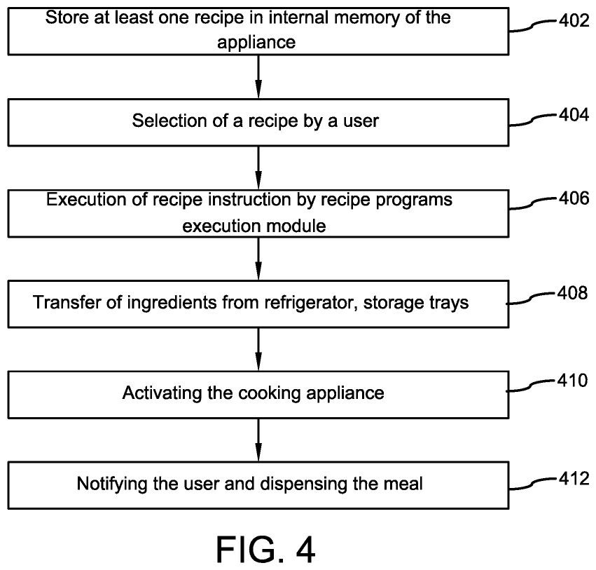

Referring initially to the drawings, FIG. 1 illustrates a simplified component diagram of one potential embodiment of a multipurpose kitchen appliance of the present invention in accordance with the disclosed architecture. The multipurpose kitchen appliance 100 of the present embodiment is designed to include a plurality of integrated appliances for multifunctional usage. The multipurpose appliance 100 is designed to be pre-programmed in order to autonomously make one or more meals, obviating the need of users to manually cook meals. The kitchen appliance 100 includes a multifunctional appliance module 102 including a plurality of appliances used for making a recipe. The appliances included in the appliance module 102 are a refrigerator 104, a stove 106, a deep fryer 108, and an oven 110. It should be noted that any other appliance can also be included in the appliance module 102 as per preferences of a user. The appliance module 102 is configured to be controlled by a control module 112 positioned inside the appliance 100 such that a processor 114 of the control module 112 executes the steps of autonomously operating the appliances of the appliance module 102 as described in FIG. 4

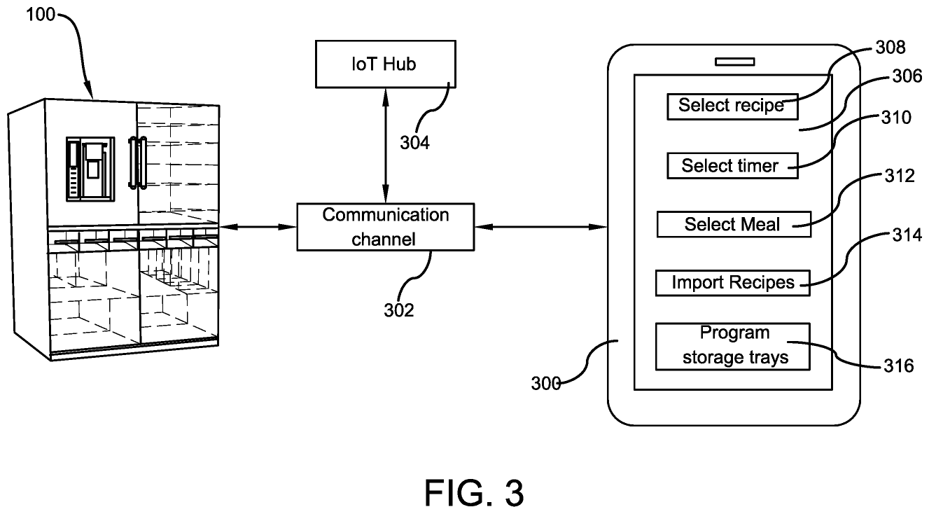

A memory module 116 of the appliance 100 is configured to store the recipe program instructions of a particular recipe program. The recipe programs can be downloaded in the memory module 116 from an internet connection using wireless module 118 or alternatively from a remote electronic device as illustrated in FIG. 3. The wireless module 118 is configured to provide one or more of wireless local area network (WLAN), short range communication (e.g. BLUETOOTH, ZigBee, etc.), near field communication (NFC) technology, wide area networks such as the Internet or mobile communication networks such as GSM, UMTS, LTE and more.

The recipe programs stored in the memory module 116 are executed by a recipe programs execution engine 120. The execution engine 120 receives an instruction from the processor 114 for executing a recipe based on input received from an input/output module 122. The input/output module 122 is configured to provide an interface for a user to interact with the appliance 100 for selecting a dish or recipe. An advantage of the multipurpose appliance 100 of the present invention is that the appliance 100 is designed to autonomously make one or more specific recipes at a predetermined time without any user intervention. An integrated clock 124 is used by the processor 114 to send a prescheduled and/or predetermined instruction signal to the engine 120 for making a predetermined recipe. This enables users to have healthy recipes on demand without the need to manually cook healthy meals.

For storing seasonings, coffee, tea powder, sugar, condiments, and other similar products, a plurality of storage components 126 in the form of storage trays are used in the multifunctional appliance 100. When a recipe is prepared, content from one or more storage trays is used wherein the trays have programmable measurements and time intervals for accommodating different recipes and menus. Using the contents stored in one or more of the storage components 126, the processor 114 is configured to activate a dispenser 128 for autonomously dispensing tea, coffee, soup, and more. The storage trays 126 may store at least meats, seafood, vegetables, cereals, pancake mixtures, eggs, bacon, and more. It should be appreciated that for making a recipe or dessert or the like, one or more of the appliances from the appliance module 102 are autonomously selected for making the recipe. A self-cleaning steaming module 130 is provided in the appliance 100 for autonomously cleaning various components of the appliance 100 after a recipe is made.

The recipe programs execution engine 120 is configured to access a recipe instruction stored in the internal memory module 116. The recipe instructions may include the use of one of the cooking appliances, ingredients, and timer information. The appliances 104, 106, 108, 110 perform the coordinated steps included in the instructions along with the ingredients pulled from the storage trays 126. The exemplary instructions executed by the execution engine 120 and the processor 114 can be mix coffee and milk from storage trays and boil at 100° C. for 3 minutes. In one embodiment, the execution engine 120 can display a notification on inability to prepare a recipe as per the recipe instructions. The processor 114 along with the engine 120 may not prepare a recipe in case an ingredient is not found in a tray or a cooking appliance required for preparing the recipe is malfunctioning or not registered.

The memory module 116 can be implemented as one or more of a computer-readable medium or media, a volatile memory unit or units, or a non-volatile memory unit or units. Memory module 116 can be expandable in some embodiments. By way of example, and not limitation, such memory module 116 may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 114 to perform a certain operation or group of operations.

For communication of instructions from the processor 114 and the execution engine 120 and between other components of the appliance 100, an internal communication bus (not shown) is used. The internal communication bus is an integrated part of the multifunctional appliance 100 and is designed to provide real time instructions to the components. Different cooking appliances, storage components, dispensers, and more are equipped with integrated circuits (ICs) for interconnection with the internal communication bus.

The input/output module 122 is preferably in the form a touch sensitive display which can be made of any state-of-the-art display technology such as LED (Light Emitting Diode) or OLED (Organic Light Emitting Diode) display, or other appropriate display technology. The module 122 comprises appropriate circuitry to present graphical and other information to a user of the appliance 100. The input/output module 122 may receive commands from a user and convert them for submission to the processor 114 for execution.

The processor 114 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 1, processor 114 may include any number of processors and/or processor cores configured to, individually or collectively, perform or direct performance of any number of operations described in the present disclosure.

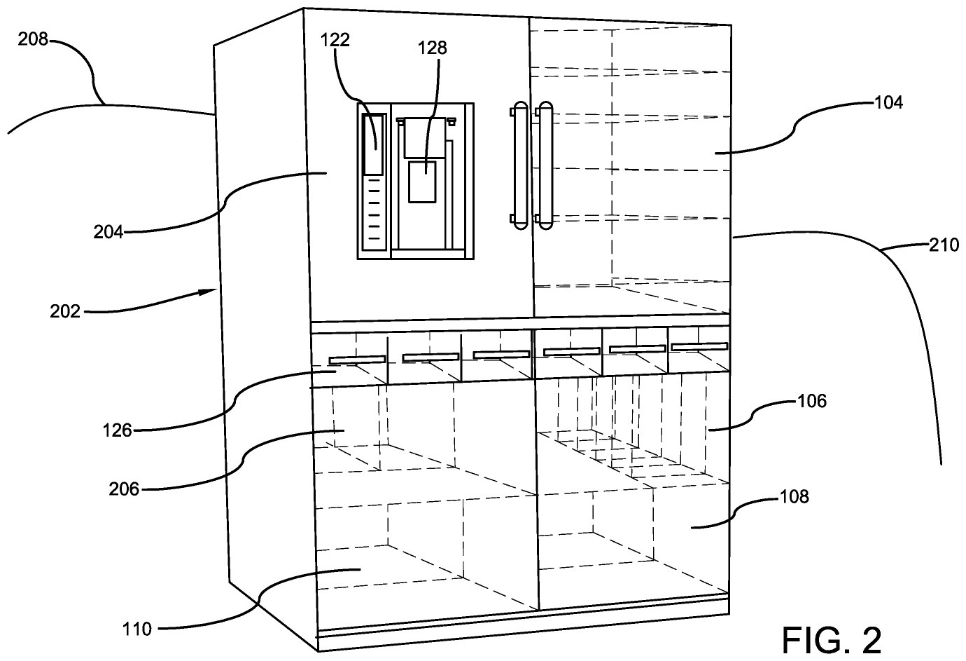

FIG. 2 illustrates a perspective view of the multifunctional kitchen appliance 100 of the present invention in accordance with the disclosed architecture. The kitchen appliance 100 can come in different shapes and sizes for accommodating needs of different users. The appliance 100 has a housing 202 made from a durable metal sheet and can have inner lining made of polystyrene. The cooking appliances 104, 106, 108, 110 can be made from durable materials that can withstand extremely high and low temperatures.

A storage house 204 is configured to house the electronic components such as control module 112 of the appliance 100. The storage house 204 also includes a coffee maker and a tea maker. The dispenser 128 is positioned on the storage house 204 and has the input/output module 122 for providing input to the appliance 100. For mixing different ingredients stored in the storage trays 126 for making a recipe, the appliance 100 has a plurality of mixing and sauteing bowls 206 that are autonomously chosen by the processor of the appliance during a recipe.

A water pipe 208 is connected to the appliance 100 for providing water for use in making dishes and for providing cleaning steam. In some embodiments, an internal storage of water is also provided in the appliance 100. Electric power is required for operation of the appliance 100 for producing recipes and accordingly, a power cord 210 is provided that is integrally connected to the appliance 100 and is configured to provide electric power. The cord 210 can be coupled to any wall mounted electric power source.

It should be noted that there is no limitation to the cooking appliance or storage trays included in the appliance 100. In some embodiments, cooking appliances may include pressure cooker, cooking bowl, rice cooker, grill and more. The integrated clock of the appliance 100 is used for enabling actuation of the appliance 100 to autonomously make meals, coffee, and more at preprogrammed times without any user intervention.

FIG. 3 illustrates a schematic view showing the connection of the kitchen appliance 100 with a remote electronic device 300 for remotely operating the kitchen appliance in accordance with the disclosed architecture. The kitchen appliance 100 can be operated and configured remotely by a user using a remote electronic device 300 such as a smartphone. The appliance 100 and the electronic device 300 are coupled using a wireless communication channel 302. Additionally, the appliance 100 may also be a part of Internet of Things (IoT) network and is connected to an IoT hub 304. The appliance 100 may receive configuration instructions from the IoT hub 304 using the communication channel 302. The communication channel 302 can be one of wireless local area network (WLAN), short range communication such as BLUETOOTH, ZigBee, and more, near field communication (NFC) technology, or mobile communication networks such as GSM, UMTS, LTE and more.

The electronic device 300 includes a software application including machine readable instructions configuring the processor of the electronic device 300 for executing the instruction. The software application 306 provides a plurality of options for a user to remotely control and operate the appliance 100. As illustrated, a “Select recipe” control 308 enables a user to select one of the pre-stored recipes in the internal memory of the appliance 100. All the recipes stored in the internal memory are displayed and one or more recipes can be selected by a user to enable the appliance 100 to autonomously prepare the recipe.

A “Select timer” control 310 is used for selecting a timer or clock value at which a specific recipe can be scheduled. The control 310 configures the integrated clock of the appliance 100 and the processor 114 of the appliance 100 executes the cooking components to prepare a meal or drink at the scheduled time. A “Select meal” control 312 is used for selecting a preconfigured meal such as a breakfast, lunch, or dinner. The preconfigured meal can be selected from a plurality of options and can be scheduled at a specific time using the “Select timer” control 310.

“Import recipes” control 314 is used for downloading a plurality of recipes and storing in internal memory 116 of the appliance 100 for execution by the recipe programs execution engine 120 and the processor 114. In some embodiments, the recipe instructions can be downloaded directly to the internal memory 116 of the appliance 100 using the input/output module.

The storage trays 126 of the appliance 100 are programmable and can be programmed using the “Program storage trays” control 316. The trays can be programmed to release a predetermined amount of content, dispensing content at predetermined times and can be programmed as per the ingredients or content stored in the storage trays 126. The trays 126 may store different meats, seafood, vegetables, cereals, pancake mixtures, eggs, bacon, stock water, and numerous other ingredients. Upon instruction from the processor 114, ingredients required for a selected recipe are transferred to one or more cooking appliance as per user's preference.

FIG. 4 illustrates a flow diagram depicting steps performed for autonomous preparation of a meal by the kitchen appliance 100 of the present invention in accordance with the disclosed architecture. Initially, one or more recipe programs or instructions are stored in internal memory of the kitchen appliance (Step 402). The recipes can be imported directly using input interface (module) of the appliance 100 or using the remote electronic device 300. Then, as per preference of a user, a recipe of a meal is selected by a user (Step 404). The recipe selection can be manually done by the user or can be autonomously based on stored preferences of the user.

Once, a recipe is selected, the recipe instructions are executed by recipe programs execution module (Step 406). Based on the recipe instructions, the execution module along with the processor of the appliance, follow the instructions and transfer a programmed quantity of the selected ingredients from the storage trays (Step 408). One or more containers or utensils are autonomously selected for transferring the selected ingredients.

Based on the requirements of the recipe, one or more cooking appliances are selected for cooking the meal based on the recipe (Step 410). Based upon the preset timer, the meal is prepared by the kitchen appliance, and then the user is notified using audio and visual notifications and the meal is dispensed (Step 412).

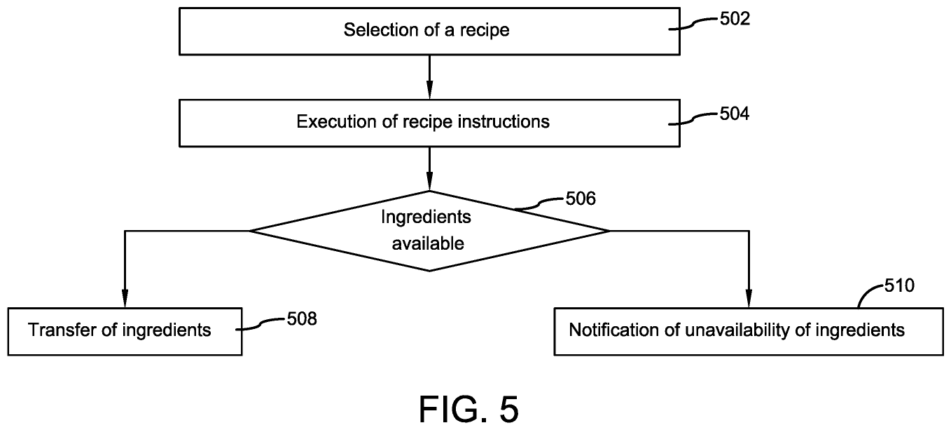

FIG. 5 illustrates a flow diagram depicting determination of required ingredients for a recipe by the kitchen appliance of the present invention in accordance with the disclosed architecture. Initially, a recipe is selected by a user or is autonomously selected based on preferences (Step 502). Based on the selected recipe, recipe instructions are executed by the processor and the execution engine (Step 504). During execution or at the onset of recipe execution, availability of ingredients required for the recipe is determined (Step 506). In situations where the ingredients are available, the ingredients are transferred to a cooking appliance (Step 508); and, in situations where the ingredients are unavailable, then a notification is provided to the user both on the kitchen appliance and on the remote electronic device notifying about unavailability of the ingredients (Step 510). In some embodiments, names of unavailable ingredients are also displayed in the notification.

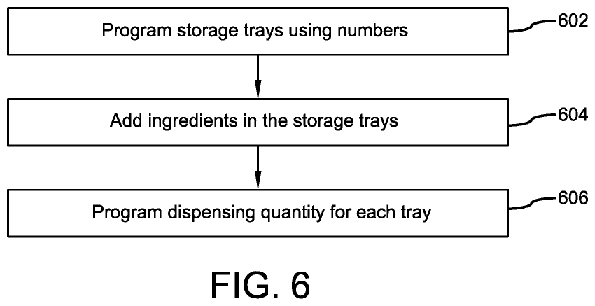

FIG. 6 illustrates a flow chart depicting a process of programming storage trays of the kitchen appliance of the present invention in accordance with the disclosed architecture. The storage trays are preferably identified using numbers for unique identification and can be programmed in numbers in any format as per preferences of a user (Step 602). Once the storage trays are programmed, ingredients are added to the storage trays (Step 604). Finally, the dispensing quantity of ingredients from each tray is programmed thereby enabling the kitchen appliance to autonomously prepare a meal without any manual intervention (Step 606).

It should be noted that in cases where a particular recipe includes a recipe for a food product requiring multiple food ingredients, different parts of the recipe program can be processed by different cooking appliances. For example, some of the components of the recipe may be processed by the stove 106 whereas other components are processed in a deep fryer 108. Control parameters for individual cooking appliances are also programmed by a user.

In non-limiting examples the appliance 100 can also include a list of favorite, frequently-prepared, or recently-prepared recipes. The appliance also enables the user-submitted modifications for generating the modified cooking instructions or custom cooking instructions.

It should be appreciated that aspects of the present invention can provide the capability, where scanning a barcode on a selected prepackaged food item can transmit the cooking instructions to the appliance 100, and the cooking instructions can be simplified to reduce or remove user intervention steps compared with traditional methods of food preparation.

Various implementations of the kitchen appliance 100 and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of embodiments have been described. Nevertheless, it will be understood that various modifications may be made without departing from the spirit and scope of the present disclosure.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “kitchen appliance”, “multipurpose appliance”, “appliance”, and “multifunctional appliance” are interchangeable and refer to the multipurpose kitchen appliance 100 of the present invention.

Notwithstanding the forgoing, the multipurpose kitchen appliance 100 of the present invention can be of any suitable size and configuration as is known in the art without affecting the overall concept of the invention, provided that it accomplishes the above stated objectives. One of ordinary skill in the art will appreciate that the multipurpose kitchen appliance 100 as shown in the FIGS. are for illustrative purposes only, and that many other sizes and shapes of the multipurpose kitchen appliance 100 are well within the scope of the present disclosure. Although the dimensions of the multipurpose kitchen appliance 100 are important design parameters for user convenience, the multipurpose kitchen appliance 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose kitchen appliance comprising:
a multipurpose appliance module having a control module and a plurality of integrated appliances for multifunctional use;
a memory module for storing a recipe program including instructions for performing said recipe program;
wherein one or more of said plurality of integrated appliances pre-programmed in order to autonomously make a meal using said recipe program;
wherein said plurality of integrated appliances selected from a group consisting of a refrigerator, a stove, a deep fryer, and an oven; and
further wherein said control module having a processor for executing autonomous operation of said plurality of integrated appliances.

2. The multipurpose kitchen appliance of claim 1, wherein said recipe program is downloaded to said memory module from an internet connection using a wireless module.

3. The multipurpose kitchen appliance of claim 2, wherein said wireless module is selected from a group consisting of a local area network (WLAN), a short range communication, a near field communication technology, a wide area network, an Internet, and a mobile communication network.

4. The multipurpose kitchen appliance of claim 2, wherein said recipe program is downloaded to said memory module from a remote electronic device.

5. The multipurpose kitchen appliance of claim 4 further comprising an execution engine for receiving said recipe program and executing said instructions for performing said recipe program.

6. The multipurpose kitchen appliance of claim 5 further comprising a clock for scheduling actuation of said execution engine at a predetermined time.

7. The multipurpose kitchen appliance of claim 6, further comprising a plurality of storage compartments having storage trays for retaining and autonomously dispensing recipe ingredients.

8. The multipurpose kitchen appliance of claim 7, wherein said recipe ingredients are selected from a group consisting of a seasoning, a coffee, a tea, a sugar, a soup, and a condiment.

9. The multipurpose kitchen appliance of claim 7, wherein said recipe ingredients are selected from a group consisting of a meat, a seafood, a vegetable, a cereal, a pancake mixture, an egg, and a bacon.

10. The multipurpose kitchen appliance of claim 7, wherein said storage trays having programmable measurements.

11. The multipurpose kitchen appliance of claim 10, wherein said storage trays having predetermined time intervals for actuation.

12. The multipurpose kitchen appliance of claim 1 further comprising a water pipe and a self-cleaning steaming module for autonomously cleaning at least one of said plurality of integrated appliances.

13. The multipurpose kitchen appliance of claim 12 further comprising an input/output module providing an interface for a user to interact with said plurality of integrated appliances for selecting said recipe program.

14. A multipurpose kitchen appliance comprising:
a multipurpose appliance module having a control module and a plurality of integrated appliances for multifunctional use;
a memory module for storing a recipe program including instructions for performing said recipe program;
an execution engine for receiving said recipe program and executing said instructions for performing said recipe program;
a clock for scheduling actuation of said execution engine at a predetermined time;
wherein one or more of said plurality of integrated appliances pre-programmed in order to autonomously make a meal using said recipe program;
wherein said plurality of integrated appliances selected from a group consisting of a refrigerator, a stove, a deep fryer, and an oven;
wherein said control module having a processor for executing autonomous operation of said plurality of integrated appliances; and
further wherein said recipe program is downloaded to said memory module from a remote electronic device.

15. The multipurpose kitchen appliance of claim 14 further comprising a plurality of storage compartments having storage trays for retaining and autonomously dispensing recipe ingredients.

16. The multipurpose kitchen appliance of claim 15, wherein said recipe ingredients are selected from a group consisting of a seasoning, a coffee, a tea, a sugar, a soup, and a condiment.

17. The multipurpose kitchen appliance of claim 15, wherein said recipe ingredients are selected from a group consisting of a meat, a seafood, a vegetable, a cereal, a pancake mixture, an egg, and a bacon.

18. The multipurpose kitchen appliance of claim 15, wherein said storage trays having programmable measurements.

19. An autonomous method of preparing a meal with a multipurpose kitchen appliance, the method comprising the steps of:
storing a recipe program in an internal memory of said multipurpose kitchen appliance;
importing said recipe program using an interface of said multipurpose kitchen appliance;
selecting said recipe program by a user;
executing instructions of said recipe program by an execution module; and
following said instructions and transferring a programmed quantity of a selected ingredient from a storage tray into a container, wherein said following said instructions and said transferring said programmed quantity of said selected ingredient are autonomous.

20. The method of claim 19 further comprising the steps of:
selecting a cooking appliance from said multipurpose kitchen appliance based upon said recipe program of the meal;
setting a timer for actuating said cooking appliance at a predetermined time; and
preparing said recipe program of the meal.
